(19) United States
(12) Patent Application Publication
(10) Pub. No.: US 2020/0044996 A1
(43) Pub. Date: Feb. 6, 2020

(54) AUTOMATIC IDENTIFICATION AND EXTRACTION OF SUB-CONVERSATIONS WITHIN A LIVE CHAT SESSION

(71) Applicant: Google Inc., Mountain View, CA (US)

(72) Inventors: Tim Johnson, San Francisco, CA (US); Kevin Greene, San Francisco, CA (US)

(73) Assignee: Google Inc., Mountain View, CA (US)

(21) Appl. No.: 14/270,932

(22) Filed: May 6, 2014

(51) Int. Cl. H04L 12/58

(52) U.S. Cl. CPC H04L 51/046

(57) ABSTRACT

Systems and methods that automatically identify and extract or distinguish sub-conversations within a live chat session, are provided. In an aspect, a system includes a reception component configured to receive comments associated with a common topic, wherein the comments are displayed via a first graphical user interface. The system further includes an identification component configured to identify a subset of the comments associated with a sub-topic within the common topic, wherein in response to identification of the subset of comments, the subset of comments are distinguished among the comments as displayed via the first graphical user interface or another graphical user interface.

### TECHNICAL FIELD

This application generally relates to systems and methods that automatically identify and extract or distinguish sub-conversations within a live chat session.

### BACKGROUND

Internet based chat systems provide a way for online users to engage in real-time conversations. Typically, these systems provide for real-time group textual messaging with a community conversation forum or “chat room” displayed as a graphical user interface (GUI) implemented in a distributed computing environment. Live chat forums are beneficial because they enable real-time communications on various topics by two or more participants of similar or divergent interests or backgrounds.

The number and frequency of messages received in a live chat forum can vary depending on the subject matter associated with the live chat forum and the number of participants engaged in the live chat forum. In some instances where a live chat forum involves many participants, it can be challenging for participants to have a coherent conversation with one another due to the high rate of messages hitting the chat forum at the same time. For example, when new messages are coming in at high rate, a user might not even have enough time to read a prior message before the new messages have pushed it off screen. It follows that in these scenarios, conversations break down fairly quickly.

### BRIEF DESCRIPTION OF THE DRAWINGS

Numerous aspects, embodiments, objects and advantages of the disclosed subject matter will be apparent upon consideration of the following detailed description, taken in conjunction with the accompanying drawings, in which like reference characters refer to like parts throughout, and in which:

FIG. 1 illustrates an example system for identifying and extracting or distinguishing sub-conversations within a live chat session, in accordance with various aspects and embodiments described herein;

FIG. 2 illustrates another example system for identifying and extracting or distinguishing sub-conversations within a live chat session associated with live streaming media, in accordance with various aspects and embodiments described herein;

FIG. 3 presents a user interface that displays a live chat forum and extracted sub-conversations within the live chat forum, in accordance with various aspects and embodiments described herein;

FIG. 4 presents a user interface that displays a live chat forum and distinguished sub-conversations within the live chat forum, in accordance with various aspects and embodiments described herein;

FIG. 5 illustrates another example system for identifying and extracting or distinguishing sub-conversations within a live chat session, in accordance with various aspects and embodiments described herein;

FIG. 6 illustrates another example system for identifying and extracting or distinguishing sub-conversations within a live chat session, in accordance with various aspects and embodiments described herein;

FIG. 7 illustrates another example system for identifying and extracting or distinguishing sub-conversations within a live chat session, in accordance with various aspects and embodiments described herein;

FIG. 8 is a flow diagram of an example method for identifying and extracting or distinguishing sub-conversations within a live chat session, in accordance with various aspects and embodiments described herein;

FIG. 9 is a flow diagram of another example method for identifying and extracting or distinguishing sub-conversations within a live chat session, in accordance with various aspects and embodiments described herein;

FIG. 10 is a schematic block diagram illustrating a suitable operating environment in accordance with various aspects and embodiments.

FIG. 11 is a schematic block diagram of a sample-computing environment in accordance with various aspects and embodiments.

### DETAILED DESCRIPTION

The innovation is described with reference to the drawings, wherein like reference numerals are used to refer to like elements throughout. In the following description, for purposes of explanation, numerous specific details are set forth in order to provide a thorough understanding of this innovation. It may be evident, however, that the innovation can be practiced without these specific details. In other instances, well-known structures and components are shown in block diagram form in order to facilitate describing the innovation.

By way of introduction, the subject matter described in this disclosure relates to systems, methods and interfaces that facilitate identifying and extracting or distinguishing sub-conversations within a live chat session. A chat or chat session refers to a text based conversation between two or more users that is live or in real-time and occurs over a wireless communication network (e.g., the Internet, a cellular network, etc.). In some aspects, in addition to text, a chat can include live voice and video conferencing features. A chat can include point-to-point communications as well as multicast communications from one sender to many receivers.

In some instances, when a chat forum facilitates real-time communication between many participants, it can be challenging for the participants to have a coherent conversation with one another. For example, with today's advances in networking technology, live video and audio streamed over a wide area network (WAN), (e.g., the Internet) has become accessible to connected people worldwide. One major component of live streams is a corresponding web chat that allows viewers to interact with each other regarding the live streamed content. Web chats accompanying live streamed content promote conversation regarding the live streamed content among viewers around the world, making the live streamed content more engaging. However, with popular live streams, due to the high rate of messages hitting the chat forum at the same time, it can be challenging for users to have a coherent conversation with another user. In these scenarios, conversations break down fairly quickly and long-form discussions are difficult to develop.

The subject disclosure addresses the problem of developing a long-form conversation between a subset of users engaged in a high-volume chat forum, such as a web chat corresponding to a live media stream. In an aspect, sub-conversations that emerge within a primary conversation of a chat session are automatically identified and broken out or otherwise distinguished from the primary conversation. Comments received in association with the chat session are filtered based on the identified sub-conversations and respectively associated therewith in real-time. The sub-conversations can be distinguished from other comments/conversations included in the chat forum by providing the sub-conversations in a separate window or by highlighting comments respectively associated with a sub-conversation in distinguishing color, font or style.

In one or more aspects, a system is provided that includes a reception component configured to receive comments associated with a common topic, wherein the comments are displayed via a first graphical user interface. The system further includes an identification component configured to identify a subset of the comments associated with a sub-topic within the common topic, wherein in response to identification of the subset of comments, the subset of comments are distinguished among the comments as displayed via the first graphical user interface or another graphical user interface.

In another aspect, a system is provided that includes a dialogue component configured to generate a first graphical user interface that displays comments associated with a common topic as the comments are received. The system further includes a sub-dialogue component configured to distinguish, via the first graphical user interface or another graphical user interface, a subset of the comments associated with a sub-topic of the common topic in response to identification of respective comments included in the subset of the comments as they are received.

In yet another aspect, a method is disclosed that includes using a processor to execute the following computer executable instructions stored in a memory to perform the following acts: receiving messages in a chat forum associated with a common topic, providing the messages within a primary messaging area of the chat forum as they are received, identifying a subset of the comments associated with a sub-topic of the common topic, and distinguishing the subset of comments among the comments as displayed within the primary messaging area, or providing the subset of the comments in a secondary messaging area of the chat forum.

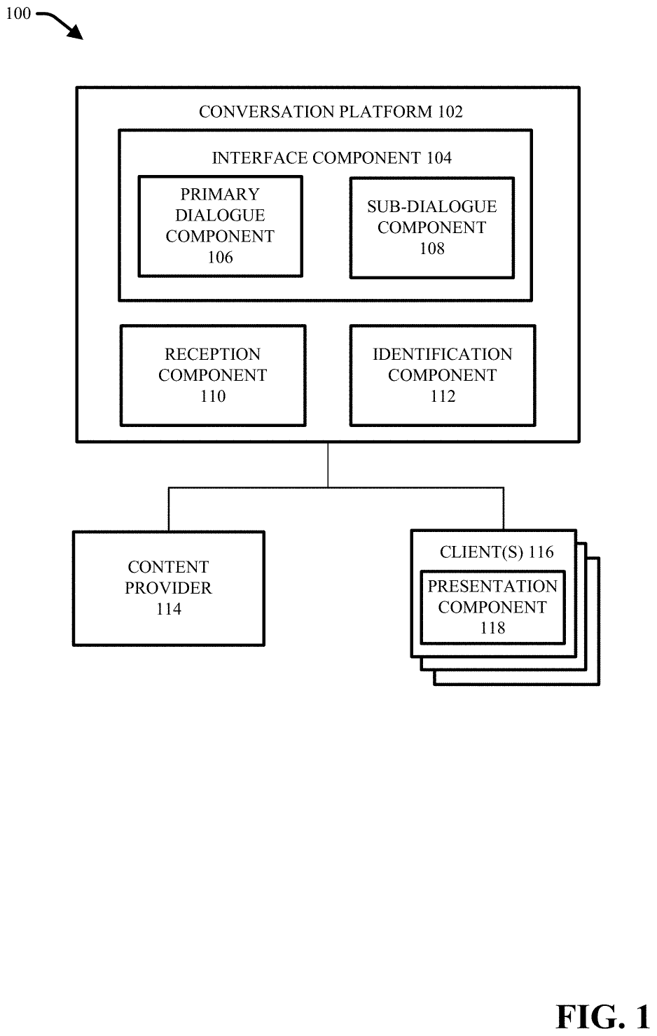

Referring now to the drawings, with reference initially to FIG. 1, presented is diagram of an example system 100 that facilitates identifying and extracting or distinguishing sub-conversations within a live chat session, in accordance with various aspects and embodiments described herein. Aspects of systems, apparatuses or processes explained in this disclosure can constitute machine-executable components embodied within machine(s), e.g., embodied in one or more computer readable mediums (or media) associated with one or more machines. Such components, when executed by the one or more machines, e.g., computer(s), computing device(s), virtual machine(s), etc. can cause the machine(s) to perform the operations described.

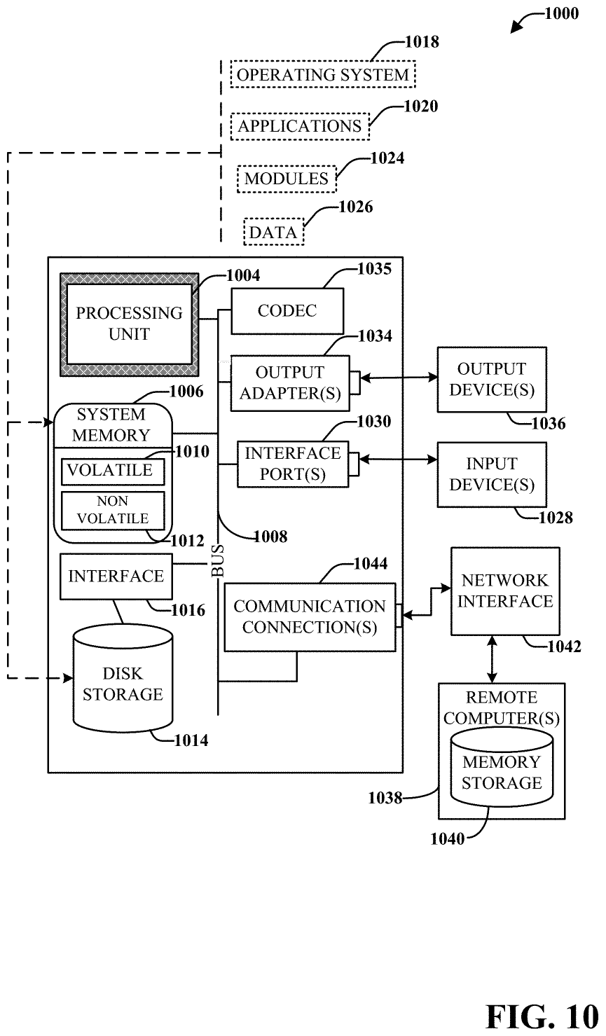

System 100 includes conversation platform 102, content provider 114 and client devices 116. Conversation platform 102 is configured to facilitate setting up and managing live chat forums/sessions between a plurality of users, via their respective client devices 116, over a wireless network (e.g., the Internet, a cellular network, etc.). The basis and subject matter associated with the live chat forum can vary. Generally, conversation platform 102, content provider 114 and client devices 116 can include memory that stores computer executable components and a processor that executes the computer executable components stored in the memory, examples of which can be found with reference to FIG. 10.

The various components and devices of system 100 can be connected either directly or via one or more networks, (not shown). Such network(s) can include wired and wireless networks, including but not limited to, a cellular network, a wide area network (WAD, e.g., the Internet), a local area network (LAN), or a personal area network (PAN). For example, a client device 116 can communicate with content provider 114, conversation platform 102 and/or another client device (and vice versa) using virtually any desired wired or wireless technology, including, for example, cellular, WAN, wireless fidelity (Wi-Fi), Wi-Max, WLAN, and etc. In an aspect, one or more components of system 100 are configured to interact via disparate networks. It is to be appreciated that although conversation platform 102 is illustrated as being a component external to content provider 114 and client devices 116, such implementation is not so limited. For example, conversation platform (and/or one or more components of conversation platform 102) can be included at content provider 114, a client device 116, another content server, and/or the cloud.

In an aspect a content provider 114 can employ conversation platform 102 to facilitate generating and managing live chat sessions regarding content or content items provided by and/or associated with the content provider 114. For example, content provider 114 can include a networked system that provides a service, sells a product or products, and/or provides various types of shared content to users via a network accessible platform (e.g., a website, a mobile application. For instance content provider 114 can include a streaming media provider configured to provide streaming media (e.g., video, live video, audio, etc.) to users via a network. The streaming media can be accessed via the respective users via their respective client devices at a network based platform (e.g., a website, a mobile application) employed by the streaming media provider. According to this example, the streaming media provider can employ conversation platform 102 to facilitate generating and managing live chat forums regarding media streamed to a plurality of different users at their respective client devices 116. In another example, content provider 114 can include an online auction and shopping website in which users buy and sell a broad variety of goods and services worldwide. According to this example, the online auction website can employ conversation platform 102 to generate and manage live chat forums/session regarding goods, services and/or auctions associated with the online auction website.

As used herein, the term content item refers to any suitable data object that can be linked to and accessed or otherwise shared via a network and includes but is not limited to: documents, articles, messages, website, webpages, programs, applications, and media items. The term media content or media item can include but is not limited to streamable media (e.g., video, live video, video advertisements, music, music videos, sound files and etc.) and static media (e.g., pictures, thumbnails). The term media content or media item includes a collection of media items such as a playlist including several videos or songs, or a channel including several videos or songs associated with a single media creator or curator.

A channel can include data content available from a common source or data content having a common topic or theme. A channel can be associated with a curator who can perform management actions on the channel. Management actions may include, for example, adding media items to the channel, removing media items from the channel, defining subscription requirements for the channel, defining presentation attributes for channel content, defining access attributes for channel content, etc. The channel content can be digital content uploaded to the internet-based content platform by a channel curator and/or digital content selected by a channel curator from the content available on the Internet-based content platform. A channel curator can be a professional content provider (e.g., a professional content creator, a professional content distributor, a content rental service, a television (TV) service, etc.) or an amateur individual. Channel content can include professional content (e.g., movie clips, TV clips, music videos, educational videos) and/or amateur content (e.g., video blogging, short original videos, etc.). Users, other than the curator of the channel, can subscribe to one or more channels in which they are interested.

Client devices 116 can include any suitable computing device associated with a user and configured to interact with a content provider 114 and/or conversation platform 102. For example, a client device 116 can include a desktop computer, a laptop computer, a television, an Internet enabled television, a mobile phone, a smartphone, a tablet personal computer (PC), or a personal digital assistant PDA. As used in this disclosure, the terms “content consumer,” “user,” or “participant” refers to a person, entity, system, or combination thereof that employs system 100 (or additional systems described in this disclosure) using a client device 116.

Various aspects of conversation platform 102 will be described herein in association with generating and managing live chat forums/sessions regarding live streaming media content streamed to a plurality of client devices 116 simultaneously or substantially simultaneously. However, it should be appreciated that various aspects of conversation platform 102 described herein can be applied to facilitating setting up and managing live chat forums/session regarding a plurality of subjects.

In an embodiment, conversation platform 102 can include interface component 104, reception component 110 and identification component 112 to facilitate generating and managing a live chat session/forum. Interface component 104 can generate and/or configure an interface that includes a community chat forum. The community chat forum can be employed by a plurality of users to conduct a live text based discussion over a wireless network. For example, interface component 104 can generate/configure a GUI having a community chat forum that is provided at a network accessible platform (e.g., a website, a mobile application) employed by conversation platform 102 or a content provider 114. Respective users can view, display and interact with an interface including a chat forum generated/configured by interface component 104 via their client devices 116 and respective presentation components 118 associated therewith. For example, a client device 116 can include presentation component 118 to render/display a GUI that includes a chat forum via a display screen of the client device.

In an aspect, presentation component 118 can include an application (e.g., a web browser) for retrieving, presenting and traversing information resources on the World Wide Web. For example, conversation platform 102 can be employed by a content provider 114 that provides and/or presents streaming media content to client devices 116 via a website that can be accessed using a browser provided on the client devices 116. According to this example, interface component 104 can generate/configure a GUI having a chat forum for inclusion and access at the website. The GUI and chat forum can be rendered at the client device using the browser in response to access of the website or a webpage associated with the website. In another example, conversation platform 102 can be employed by a content provider 114 that provides and/or presents streaming media content to client devices 116 via a mobile application platform. Interface component 104 can generate/configure a GUI having a chat forum for inclusion and access via the mobile application platform. According to this example, presentation component 118 can employ a client application associated with content provider 114 that can access the mobile application platform of content provider 114 and render the GUI having chat forum associated therewith.

A chat forum generated/configured by interface component 104 can include an area of a GUI configured to receive and post comments or messages in real-time from a plurality of users having access to the GUI, such as via a network based platform (e.g., a website, a mobile application, etc.). For example, the chat forum can be provided in a window, column, panel, tab or other type of designated area of a GUI. In an aspect, the chat forum can include a messaging area in which messages and input received from various users is displayed in real-time (or near real-time). The messages and input displayed in the messaging area are rendered in live manner (e.g., in real-time or near real-time) in response to receipt thereof, and organized based on the order in which the messages or input is received. For example, as messages are received, they can be displayed in an ascending or descending order with respect to a previously received message. As new messages are received in the messaging area, old messages can be pushed out of the visible portion of the messaging area. Old messages can be and accessed by scrolling. In an aspect, the chat forum can be associated with an input section that allows users to type or otherwise provide data input (e.g., in the form of text, symbols, attachments, multimedia, etc.) for display in the messaging area.

A chat forum generated by interface component 104 can be employed to facilitate live discussion between a plurality of users on various topics. In an aspect, a chat forum generated by interface component 104 can be associated with a particular discussion topic or subject matter. For example, interface component 104 can generate a first chat forum that facilitates discussion of a first topic, a second chat form that facilitates discussion of a second topic, a third chat forum that facilitates discussion of a third topic, etc. According to this example, a content provider 114 that is a streaming media provider can employ conversation platform 102 to generate different chat forums that facilitate discussion of respective media items available at the streaming media provider. For example, interface component 104 can generate a first chat forum for inclusion in a first GUI associated with a first live streaming video that facilitates live discussion of the first live streaming video amongst the many users viewing the first live streaming video around the world. Interface component 104 can also generate a second chat forum for inclusion in a second GUI associated with a second live streaming video that facilitates live discussion of the second live streaming video amongst a plurality of users.

In an aspect, interface component 104 can include primary dialogue component 106 and sub-dialogue component 108. Interface component 104 can employ primary dialogue component 106 to group all messages/comments (or a superset of the messages/comments) received in association with a discussion topic for which a chat forum is initially based. For example, primary dialogue component 106 can generate an initial or primary messaging area of a chat forum for a discussion topic in which all messages/comments (or a superset of the messages/comments) received by conversation platform 102 regarding the discussion topic are provided. Interface component 104 can include sub-dialogue component 108 to distinguish and/or extract subsets of messages received in the chat forum that are associated with a sub-topic of the initial discussion topic.

For example, as many users conduct discussion of a particular discussion topic for which a chat forum is based in a live fashion, what starts as a coherent conversation degenerates into multiple concurrent conversations that are hard to keep separated. The problem is that chat forums are traditionally designed to support one conversation only. However, naturally, a primary discussion topic for which a chat forum is based can spark many concurrent sub-conversations. As more and more users join the conversation topic in a live manner, without a mediator, it becomes difficult to follow what messages and comments are responsive and/or relevant to one another.

Traditionally, to sub-conversations that emerge within a primary conversation topic are not distinguished within the chat forum. The equivalent design in the real world would be a party where a large group of people stands in a room and screams out each remark. However, in the real world, people can easily manage concurrent conversations. The simplest example of this is a cocktail party. At a party, people break up into small groups, each having their own conversation. Each person focuses on their conversation but at the same time is able to overhear bits and pieces from the neighboring groups.

Sub-dialogue component 108 is configured to dynamically modify a chat forum interface over time to capture the real world mechanisms for establishing and managing concurrent sub-conversations that develop from an initial conversation topic. In particular, sub-dialogue component 108 is configured to extract and/or distinguish messages/comments associated with sub-conversations that emerge within a primary conversation topic of a live chat forum. As discussed below, the sub-conversations and messages/comments belonging thereto can be automatically identified in real-time by conversation platform 102 (e.g., via identification component 112). Extracted and/or distinguished sub-conversations can further be associated with or tied to the chat forum primary discussion topic from which they originated. For example, an extracted or distinguished sub-conversation can include a title or header information pointing to the primary discussion chat forum from which it originated as well as the point in the primary discussion chat forum at which the sub-conversation originated.

In an aspect, in response to identification of a sub-conversation that that develops within a primary conversation topic, sub-dialogue component 108 can generate a sub-dialogue messaging area (e.g., a different graphical display area, window, panel, tab, etc.) that is separated from the initial or primary messaging area. In particular, sub-dialogue component can take a sub-conversation identified by conversation platform 102 and render it in a manner that distinguishes it from the primary conversation topic. For example, sub-dialogue component 108 can generate a separate sub-dialogue messaging area for each sub-conversation and arrange them in columns side-by-side. In another example, sub-dialogue component 108 can show each sub-conversation in a different window that can be resized and repositioned. Sub-dialogue component 108 can further include messages associated with a sub-conversation in the sub-dialogue messaging area for that sub-conversation. For example, as new messages are received that are associated with the sub-conversation, they can be displayed (in real-time) in the sub-dialogue messaging area for the sub-conversation. In an aspect, separate windows or messaging areas generated for sub-conversations can allow a user to interact directly therewith. For example, a user can provide input directly into a sub-dialogue messaging area established for a sub-conversation as opposed to the input area associated with the primary messaging area.

In an aspect, messages associated with a sub-conversation for which a sub-dialogue messaging area is generated can also be included in the primary messaging area. In another aspect, messages associated with a sub-conversation are removed from the primary messaging area. According to this aspect, a note or marker can be provided in the primary discussion area at a place where a sub-conversation began pointing to or linking to the sub-conversation. The note or marker can include information describing the sub-topic of the sub-conversation. It should be appreciated that sub-dialogue component 108 can create any number N of sub-dialogue messaging areas for a particular chat forum depending on the number of sub-conversations that emerge.

In another aspect, rather than generating separate sub-dialogue messaging areas for emergent sub-conversations, sub-dialogue component 108 can distinguish messages/comments associated with a sub-conversation within the primary messaging area. For example, sub-dialogue component 108 can highlight messages/comments associated with a sub-conversation in a different color than other comments/messages included in the primary messaging area. In another example, sub-dialogue component 108 can provide text of messages/comments associated with a sub-conversation in a different color than text of other comments/messages included in the primary messaging area. In another example, sub-dialogue component 108 can render text of messages/comments associated with a sub-conversation with a unique stylistic feature (e.g., font type, bold, underline, italic, size, etc.) to distinguish them over text of other comments/messages included in the primary messaging area. In yet another example, sub-dialogue component 108 can employ badging as a way to indicate that that a message belongs to a particular sub-conversation. Badging involves associating a small symbol or picture with a message/comment to indicate its association with a particular sub-conversation. For example, comments in sub-conversation A might have a red circle in the upper left corner and comments in sub-conversation B might have a blue circle in the upper left corner.

Reception component 110 is configured to receive messages/comments associated with a chat forum provided by conversation platform 102. In particular, reception component 110 is configured to receive messages/comments from users (e.g., via their respective client devices) regarding a conversation topic for which a chat forum is based and/or a sub-conversation topic associated with the chat forum. In response to reception of messages/comments, interface component 104 can provide the received comments in an appropriate area of the chat forum in the GUI. For example, interface component 104 can provide received comments in the primary messaging area (e.g., using primary dialogue component 106) when the comments are associated with the initial discussion topic of the chat forum. Interface component 104 can also provide received comments in a sub-dialogue messaging area (e.g., using sub-dialogue component 108) when the comments are associated with a sub-conversation topic.

In an aspect, interface component 104 can generate a chat forum in response to receipt of an initial comment by reception component 110 regarding a particular topic. For example, in response to receipt of an initial comment regarding a live streaming video, interface component 104 can generate a community chat forum for the live streaming video. The community chat forum can then be opened up for reception of additional comments/messages (e.g., by reception component 110) from a plurality of users in real-time regarding the live-streaming video.

Identification component 112 is configured to automatically identify sub-conversations that emerge within a primary conversation topic of a chat forum. In response to identification of a sub-conversation, identification component 112 can instruct interface component 104 to distinguish and/or extract the sub-conversation. In addition, once a sub-conversation has been identified and distinguished/extracted, identification component 112 can analyze newly received comments/messages associated with the live chat forum to determine or infer whether they belong to the sub-conversation. In response to a determination that a newly received comment/message belongs to the sub-conversation, identification component 112 can instruct interface component 104 to associate the newly received comment/message with the sub-conversation. As a result, as new comments are received for the chat forum in real-time (or live), they can be automatically distinguished and associated with a particular sub-conversation to which they belong.

In an aspect, identification component 112 can further monitor and analyze sub-conversations in similar manner to the primary conversation of a chat forum to identify secondary sub-conversations that develop within the sub-conversation. In response to identification of secondary sub-conversations within a sub-conversation, identification component 112 can similarly instruct interface component 104 to distinguish/extract the secondary sub-conversation from the sub-conversation and provide any new messages associated with the secondary sub-conversation with the secondary sub-conversation.

Identification component 112 can employ various techniques to automatically identify sub-conversations that emerge within a conversation topic of a chat forum. In an aspect, users participating in a chat forum (e.g., providing comments or reading comments) can facilitate identification of sub-conversations included in a primary discussion topic of a chat forum. According to this aspect, interface component 104 can allow users to mark or tag comments that are associated with a sub-conversation. Identification component 112 can then employ the marked comments to determine whether they belong to a particular sub-conversation and/or to identifying other (non-marked) comments related to the sub-conversation.

For example, interface component 104 can allow a user to “star” a message/comment (or otherwise mark the message/comment with a symbol) that the user considers a start of a sub-conversation topic. According to this example, once a comment/message has been starred or marked as the beginning of a sub-conversation topic, identification component 112 can identify other comments that are responsive to the starred comment, either directly or indirectly, as belonging to a sub-conversation based on the starred comment. For example, identification component 112 can identify comments that refer to the starred comment or that refer to another comment that refers to the starred comment, as belonging to the sub-conversation topic associated with the starred comment.

In another aspect, interface component 104 can allow users to mark or star other users associated with a sub-conversation topic. For example, as a sub-conversation initiates and develops, it generally involves a subset of the chat forum participants. These would include the participant that initiated the sub-conversation topic and one or more other participants that responded to the initiating participant. According to this example, a user could star, mark, or otherwise identify one or more participants of the sub-conversation. In an exemplary embodiment, users can be encouraged to star or mark at least the initiator of the sub-conversation. Once a user has been starred or marked, identification component 112 can identify other comments that are responsive to the starred/marked user, either directly or indirectly, as belonging to a sub-conversation. For example, identification component 112 can identify received comments that are responsive to a comment provided by the starred user or that are responsive to a comment of another user that is responsive to a comment of the starred user.

In another aspect, interface component 104 can allow users to mark or star key words or phrases included in a message or comment. For example, a user could tag the name of an actor or the name of a place. According to this aspect, identification component can identify (e.g., using text analysis software) other comments/messages that include reference to the tagged word or phrase, either directly or indirectly, as belonging to a particular sub-conversation topic.

In some aspects, comments that are responsive to another comment, user, word or phrase, in a chat forum can be associated with metadata indicating the comment, user, word or phrase to which it is responsive. For example, a user can select a comment or user in the chat forum and hit a reply button associated with the comment or user to reply to the comment or user directly. In response to selection of the reply button associated with a comment or user, interface component 104 can generate a form field that allows the user to type a response message to the comment or user. By typing a response message in the form field to facilitate posting the response message, information can be included (e.g., in the form of metadata) in the response message identifying the comment or user to which it is responsive. Identification component 112 can employ this metadata to establish a link between one or more comments that are responsive to one another, either directly or indirectly.

In another aspect, when providing a message/comment in the chat forum, users can also indicate what comment/message, user, and/or sub-conversation their message/comment is responsive to or associated with. For example, when providing a message to the chat forum, a user can employ a symbol, text, code or other type of identifying information to tag or associate with the message to indicate a comment/message, username, or sub-conversation the message is associated with (e.g. by using @mentions).

It should be appreciated that by allowing users to what influence comments, users, and/or words or phrases belonging to sub-conversations, it can become difficult to regulate which comments are worthy of distinguishing as a sub-conversation. For example, a one user may think that a particular comment is the beginning of a new conversation topic and another user may think otherwise. In another example, one user may think a comment is associated with a first sub-conversation while another user may think the comment is associated with a second sub-conversation. Accordingly, identification component 112 can employ various mechanisms to regulate determining whether a subset of comments constitutes a sub-conversation worthy of distinguishing, and to facilitate determining whether a particular comment is associated with a particular sub-conversation.

In one aspect, identification component 112 can employ a crowd source mechanism to regulate determining whether a subset of comments constitutes a sub-conversation worthy of distinguishing and to facilitate determining whether a particular comment is associated with a particular sub-conversation. For example, interface component 104 can allow participants of the chat forum (e.g., any of the participants or an authorized subset of the participants) to mark comments and/or users they consider associated with a particular sub-conversation. According to this example, identification component 112 can determine whether a subset of comments constitutes a sub-conversation worthy of distinguishing based on the number and percentage of users that consider the comments in the subset associated with the sub-conversation. For example, where X number of users and/or Y percentage of users consider a particular comment the beginning of a sub-conversation (as determined based on tagging or marking of the comment by the respective users), identification component 112 can classify the particular comment (and those comments responsive the particular comment) worthy of distinguishing as a sub-conversation. Similarly identification component 112 can determine whether a comment is associated with a particular sub-conversation based on the number and percentage of users that consider the comment in the subset associated with the sub-conversation. For example, where N number of users and/or M percentage of users consider a particular comment as belonging to a particular sub-conversation (as determined based on tagging or marking of the comment by the respective users), identification component 112 can associate the particular comment with the particular sub-conversation.

In another aspect, identification component 112 can employ thresholds regarding number of comments and/or number of participants associated with a sub-conversation to regulate determining whether a subset of comments constitutes a sub-conversation worthy of distinguishing. For example, identification component 112 can monitor a string of related comments that could potentially develop into a sub-conversation worthy of distinguishing. In an aspect, identification component 112 can initialize monitoring the string of comments based on marks or tags (e.g., as marked or tagged by chat forum participants) associated with the comments, or users providing the comments, indicating association with a particular sub-conversation. Identification component 112 can further characterize the string of related comments as a sub-conversation for distinguishing and/or extracting in response to the string of comments reaching a threshold of X or more comments and/or in response to the string of comments being provided by Y or more different participants.

In addition to or in the alternative of employing user input (e.g., related to marking of comments, users, or words/phrases associated with sub-conversations) to facilitate identifying sub-conversations and comments respectively associated therewith, identification component 112 can employ natural language processing (NLP) techniques to analyze messages received in chat forum. Using various NLP techniques, identification component 112 can derive the meaning of and relationships between messages to facilitate determining or inferring emergent sub-conversations. For example, identification component 112 can employ coreference resolution techniques whereby identification component 112 analyses a sentence or text a message/comment to determine which words (“mentions”) refer to the same objects (“entities”). Anaphora resolution is a specific example of this task, and is specifically concerned with matching up pronouns with the nouns or names that they refer to. The more general task of coreference resolution also includes identifying so-called “bridging relationships” involving referring expressions. For example, in a sentence such as “He entered John's house through the front door”, “the front door” is a referring expression and the bridging relationship to be identified is the fact that the door being referred to is the front door of John's house (rather than of some other structure that might also be referred to).

In another example, identification component 112 can employ discourse analysis to identify messages/comments associated with sub-conversations. This rubric includes a number of related tasks. One task is identifying the discourse structure of connected text or the nature of the discourse relationships between sentences or phrases (e.g. elaboration, explanation, contrast). Another possible task is recognizing and classifying the speech acts in a chunk of text (e.g. yes-no question, content question, statement, assertion, etc.).

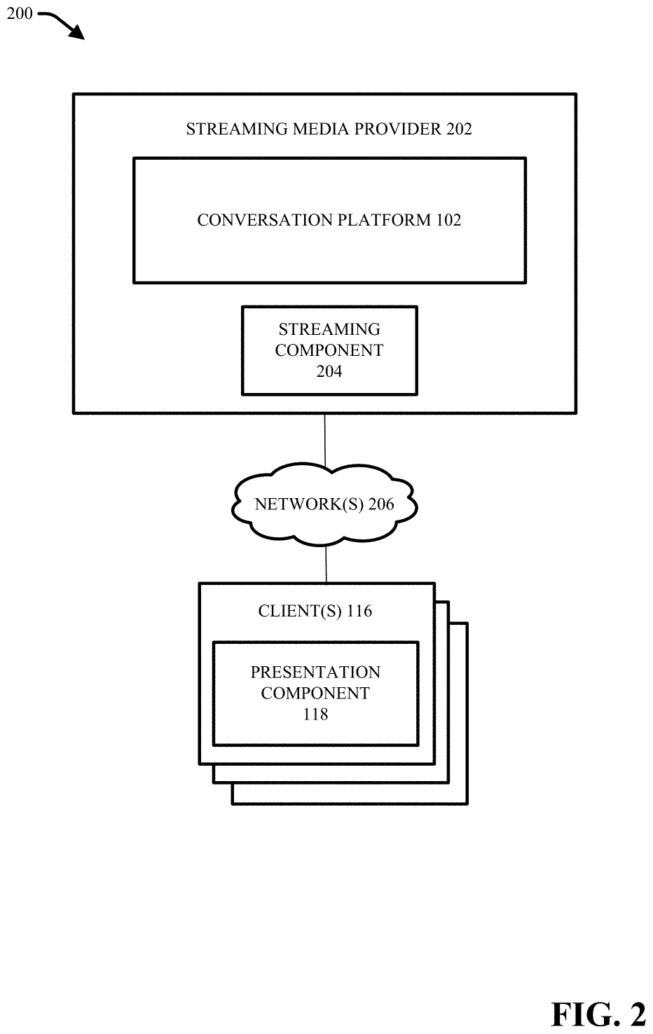

FIG. 2 presents another example system 200 that facilitates identifying and extracting or distinguishing sub-conversations within a live chat session, in accordance with various aspects and embodiments described herein. System 200 can include same or similar features and functionalities as system 100. Repetitive description of like elements employed in respective embodiments of systems and components described herein are omitted for sake of brevity.

System 200 demonstrates an example system wherein a streaming media provider 202 employs conversation platform 102 to facilitate generating and managing live chat forums in association with streaming media provided by streaming media provider 202. For example, streaming media provider 202 can employ streaming component 204 to stream video and/or audio to a plurality of client devices 116 via one or more networks 206 for viewing thereof. Networks 206 can include wired and wireless networks, including but not limited to, a cellular network, a wide area network (WAD, e.g., the Internet), a local area network (LAN), or a personal area network (PAN).

In association with viewing streamed media, users of client devices 116 can access a chat forum provided by conversation platform 102 to conduct live discussion of the streamed media. For example, using respective presentation components 118, client devices 116 can access and display a graphical user interface (e.g., generated/configured by interface component 104) that provides the streamed media and a chat forum designed for community discussion regarding the streamed media (e.g., using a browser, mobile application, etc.). In an aspect, the streamed media is live streamed media delivered to client devices 116 at the same or substantially same time. In another aspect, the streamed media is streamed to client devices 116 in a manner to effectuate synchronized playback of the streamed media at the respective client devices. According to these aspects, users of client devices 116 can employ a chat form provided by conversation platform 102 to discuss the streamed media as it is played/received simultaneously (or substantially simultaneously) by each of the client devices.

In an aspect, streaming media provider 202 has access to a voluminous quantity (and potentially an inexhaustible number) of shared media (e.g., video and/or audio) files for streaming to client devices 116 on demand and/or in a live manner via streaming component 204. The media can be stored in memory associated with the streaming media provider 202 and/or at various servers employed by the media provider and accessed by client devices 116 using a networked platform (e.g., a website platform, a mobile application, etc.) employed by the streaming media provider 202.

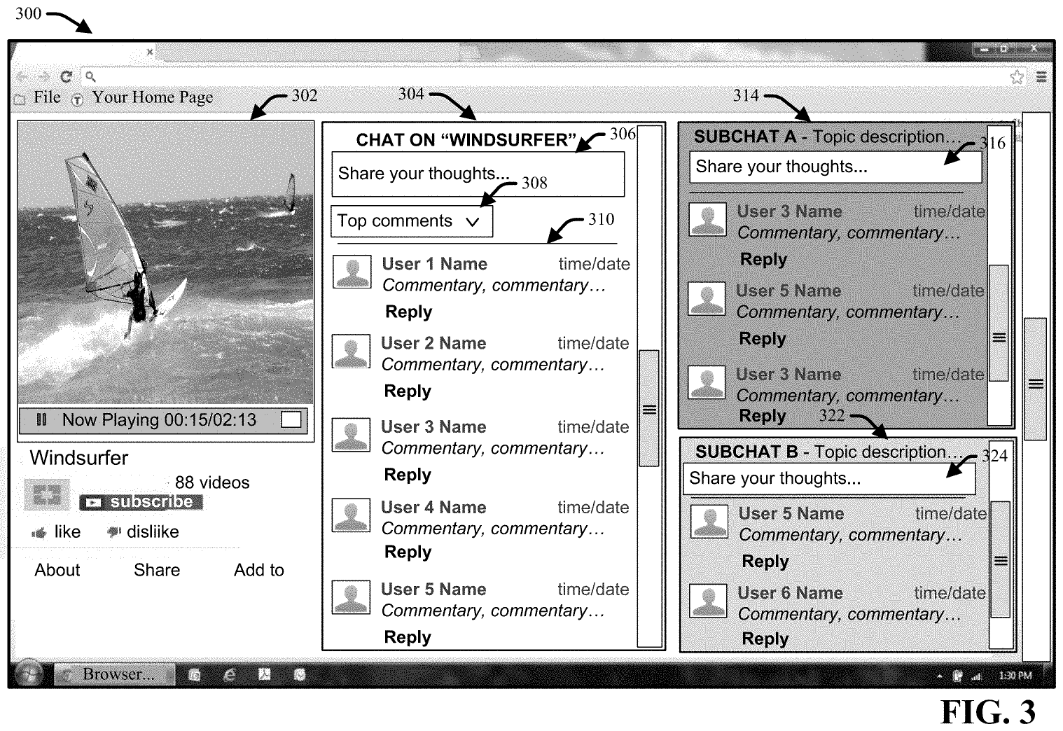

FIG. 3 presents an example user interface 300 generated/configured by interface component 104 in accordance with various aspects and embodiments described herein. Interface 300 demonstrates an example embodiment of a live chat forum that includes a primary messaging area 310 (e.g., window 304) and one or more sub-dialogue messaging areas (e.g., sub-dialogue messaging areas of windows 314 and 322) generated in response to identification and extraction (e.g., via identification component 112) of sub-conversations that emerged within a general discussion conducted in the primary messaging area 310. Repetitive description of like elements employed in respective embodiments of systems, interfaces and methods described herein are omitted for sake of brevity.

The chat forum provided in interface 300 (composed of windows 304, 314 and 322) is configured for discussion of the video entitled “Windsurfer,” also being displayed and currently playing in a video player 302 included in interface 300. Interface 300 depicts three separate windows respectively including discussion regarding Windsurfer. A first window 304 provides a primary messaging area 310 for open and general discussion of the video Windsurfer. A second window 314 provides a sub-dialogue messaging area that includes a sub-conversation (e.g., suchat A) that emerged from the open and general discussion conducted in the primary discussion area. A third window 322 provides another sub-dialogue messaging area that includes a sub-conversation (e.g., suchat B) that emerged either from the open and general discussion conducted in the primary discussion area or from subchat A.

In an aspect, users viewing or accessing video Windsurfer are presented with interface 300. The respective users can employ the primary messaging area 310 included in window 304 to provide comments and messages regarding the video. For example, users can type comments in data input field 306 for posting in primary messaging area 310 in real-time. In an aspect, users can choose to organize comments provided within primary messaging area using filter box 308. For example, filter box 308 is set to “top comments” such that the top comments are displayed in primary messaging area. Other filters that can be employed via filter box 308 can include sorting by time stamps of the comments (e.g., most recent or least recent) or sorting by user name.

In an aspect, when a comment received in data input field 306 is associated with subchat A or subchat B, the comment is posted in the respective sub-dialogue messaging areas of windows 314 or 322. As additional comments are posted to primary messaging area 310 and new sub-conversations are identified therein, additional sub-dialogue messaging areas/windows can be added to interface 300. Respective users can also select subchat A or subchat B for providing comments specifically associated therewith. For example, subchat A and subchat B can each respectively include data input fields 316 and 322 for provision of comments to be posted directly into the respective subchats. Users can also select a specific user or comment to reply to in the primary messaging area and/or a sub-dialogue messaging area.

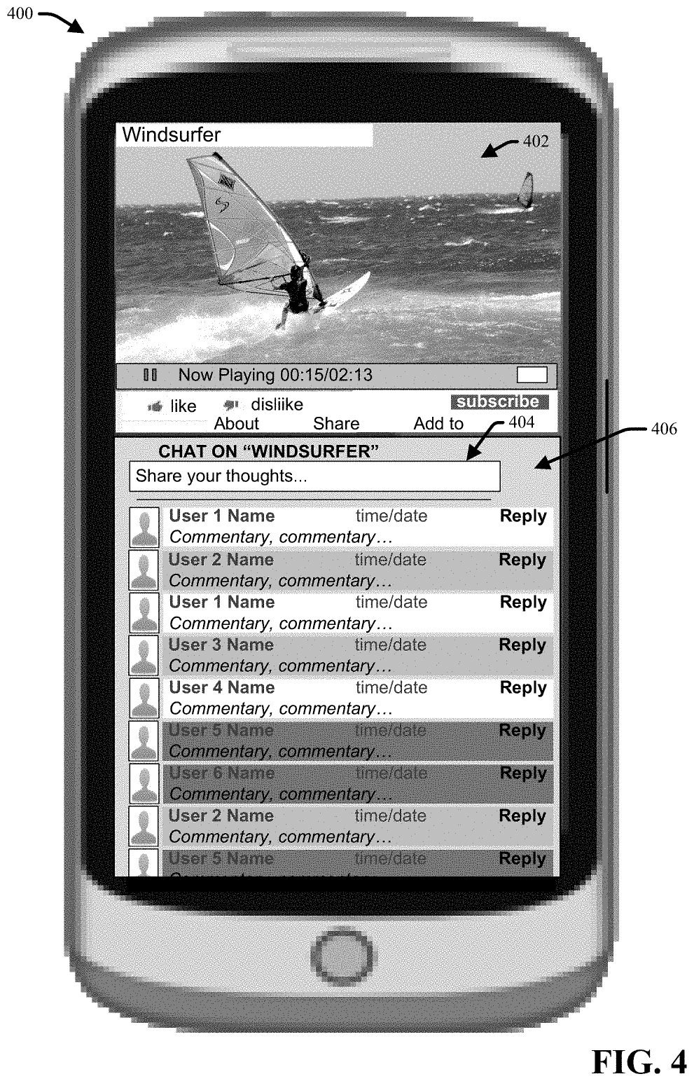

FIG. 4 presents another example user interface 400 generated/configured by interface component 104 and rendered on a mobile device (e.g., a tablet or smartphone) in accordance with various aspects and embodiments described herein. Repetitive description of like elements employed in respective embodiments of systems, interfaces and methods described herein are omitted for sake of brevity.

Similar to interface 300, interface 400 includes a primary messaging area 406 wherein messages received in association with a live chat session on the video “Windsurfer” are provided. Interface 400 also includes a video player 402 wherein the video “Windsurfer” is played and an input field 404 wherein users can enter input for inclusion in the live chat forum. However, unlike interface 300 wherein sub-chats or sub-conversation are distinguished in separate sub-dialogue messaging areas, in interface 400 the sub-conversations are distinguished within the primary messaging area 406. In particular, messages belonging to respective sub-conversations of the live chat are highlighted in different colors or color shades. For example, messages that are not associated with a sub-conversation are provided in white while messages provided in a first sub-conversation are highlighted in light grey. Messages associated with a second sub-conversation are highlighted in dark grey. It should be appreciated that various techniques can be employed to distinguish messages belonging to sub-conversations within primary messaging area 406. For example, the respective messages can be rendered in a different font, font color, highlight color or font style.

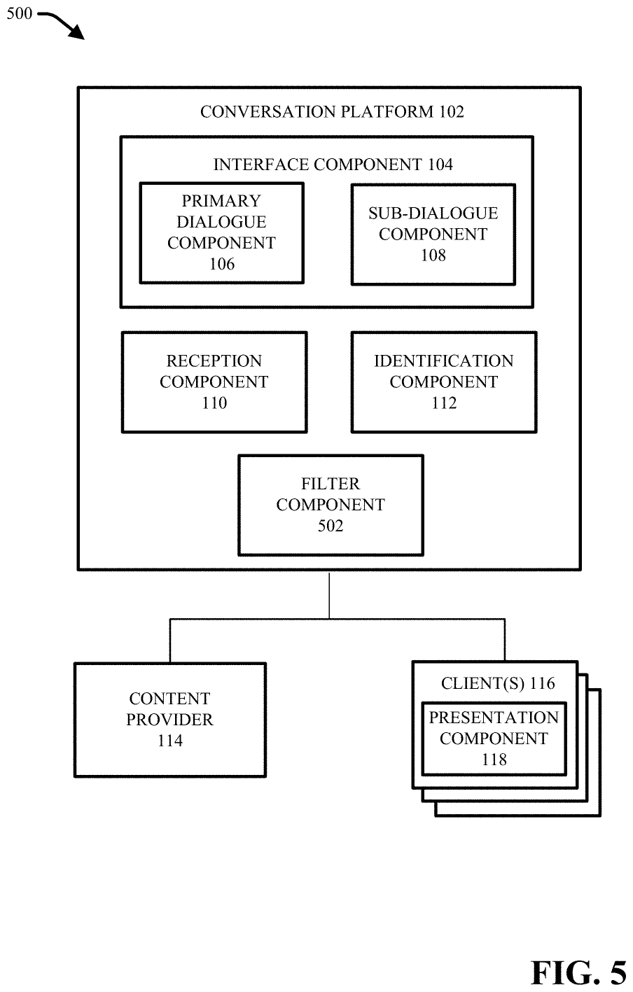

FIG. 5 presents another example system 500 that facilitates identifying and extracting or distinguishing sub-conversations within a live chat session in accordance with various aspects and embodiments described herein. System 500 can include same or similar features and functionalities as system 100 with the addition of filter component 502 to conversation platform 102. Repetitive description of like elements employed in respective embodiments of systems and components described herein are omitted for sake of brevity.

Filter component 502 is configured to filter comments/messages included in a chat forum based on various characteristics. In particular, filter component 503 can filter comments/messages for display in a primary messaging area and/or sub-dialogue messaging area based on inclusion or exclusion of various features related to the content of the comments/messages or a characteristic of a user that provides the comments/messages. For example, filter component 502 can filter comments/messages for display in a primary messaging area and/or sub-dialogue messaging area to remove messages including profanity or vulgar language. In another example, filter component 502 can filter comments/messages displayed in a primary messaging area and/or sub-dialogue messaging area based on inclusion (or exclusion) of reference to a particular person, place, thing, event, or topic. According to this example, filter component 502 can remove messages for display in a primary messaging area or sub-dialogue messaging area of a chat forum for a live video of football game that include reference to, or that are responsive to a message that includes reference to, a particular player, a particular play, a particular quote, or a particular topic.

In another example, filter component 502 can filter comments/messages for display in a primary messaging area and/or sub-dialogue messaging area based on a characteristic of a user that provides a message/comment, including but not limited: an identity of the user, a demographic feature of the user (e.g., age, gender, marital status, political affiliation, language, etc.), a social relationship of the user, a context of the user, a preference of the user, or a level of expertise of the user. For instance, a user can employ filter component 502 to filter messages displayed in a primary messaging area or sub-dialogue messaging area so that only messages/comments from other users that are “friends” of the user are displayed. Similarly, filter component 502 can filter messages so that messages from a user belonging to a particular demographic are not displayed.

In an aspect, filter component 502 can automatically filter comments/messages for display in a primary messaging area and/or sub-dialogue messaging area of a chat forum based on a known or inferred preference of a user to which the chat forum is displayed. In another aspect, a user viewing/accessing the chat forum can set a filter for application by filter component 502. For example, the user could select one or more filters from a pre-set list of filters and/or provide freestyle terms or phrases (e.g., user names, persons, places, things, topics, etc.) to indicate what comments/user to include or exclude. It should be appreciated that filter component 502 can filter existing messages/comments and any potential message/comments that are received after application of the filter.

In an aspect, a user can employ filter component 502 to characterize sub-conversations for distinguishing from a primary conversation associated with a chat forum. For example, a user of the chat forum can provide input using filter component 502 requesting that messages/comments having certain characteristics (e.g., based on the content of the message and/or the provider of the message) be distinguished as a sub-conversation and provided in a sub-dialogue messaging area of the chat forum. In response to the input, sub-dialogue component 108 can generate a sub-dialogue messaging area and existing comments and/or newly received comments having the specified characteristics can be provided within the sub-dialogue messaging area. For instance, a user participating in a chat forum for a live video of cooking show that demonstrates cooking a six course meal can employ filter component 502 to request that comments on prepping the appetizer be provided in a subchat. In response, sub-dialogue component 108 can create a sub-dialogue messaging area for appetizer discussion. According to this aspect, subchats requested and created based on a particular user's specification can be made available to only to the particular user, shared with one or more specified user's or shared with the entire chat forum.

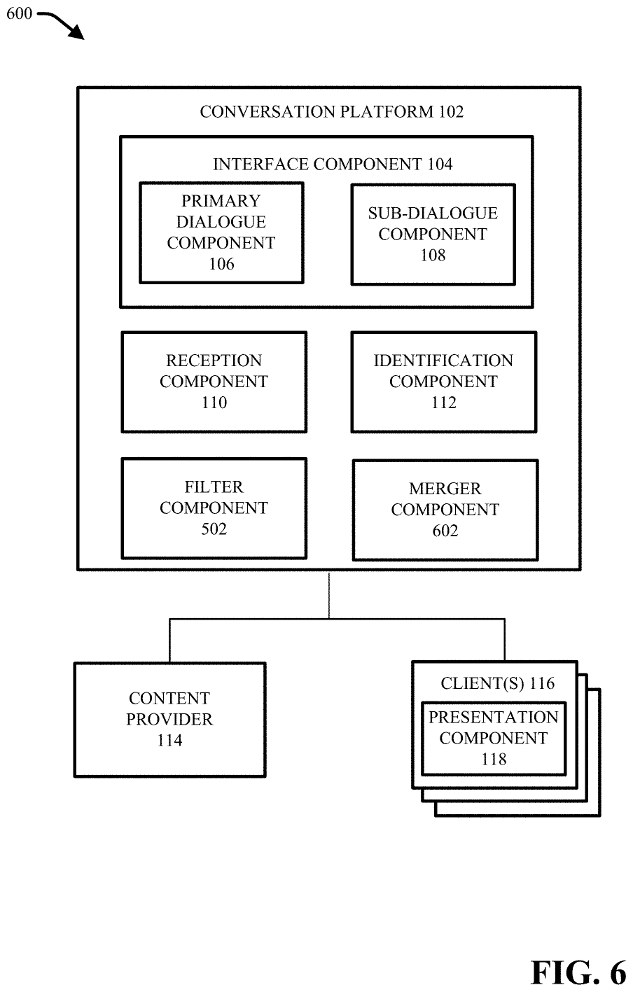

FIG. 6 presents another example system 600 that facilitates identifying and extracting or distinguishing sub-conversations within a live chat session in accordance with various aspects and embodiments described herein. System 600 can include same or similar features and functionalities as system 500 with the addition of merger component 602 to conversation platform 102. Repetitive description of like elements employed in respective embodiments of systems and components described herein are omitted for sake of brevity.

Merger component 602 is configured to monitor sub-conversations identified and distinguished/extracted in a chat forum to identify two or more sub-conversations that evolve into similar, complimentary and/or related topics (e.g., using NLP or other techniques employed by identification component 112 to facilitate identifying sub-conversations). Merger component 602 can then merge the two or more sub-conversations into a single sub-conversation. For example, merger component 602 can extract the messages/comments associated with the similar, complimentary and/or related topics from the respective sub-conversations and combine them into a new sub-conversation.

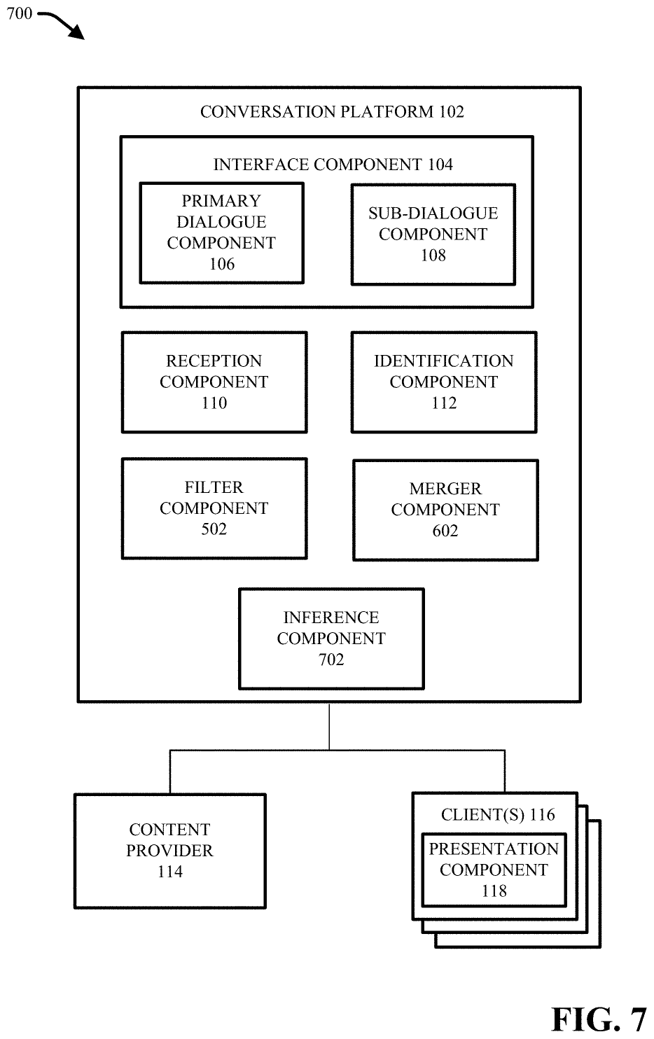

FIG. 7 presents another example system 700 that facilitates identifying and extracting or distinguishing sub-conversations within a live chat session in accordance with various aspects and embodiments described herein. System 700 can include same or similar features and functionalities as system 600 with the addition of inference component 702 to conversation platform 102. Repetitive description of like elements employed in respective embodiments of systems and components described herein are omitted for sake of brevity.

Inference component 702 is configured to provide for or aid in various inferences or determinations associated with aspects of conversation platform 102. For example inference component 702 can facilitate identification component 112 with identifying messages/comments that are associated with a sub-conversation topic amongst a primary conversation topic. In another example, inference component 302 can facilitate merger component 602 with identifying portions of distinguished sub-conversations that evolve into similar, complimentary and/or related topics.

In order to provide for or aid in the numerous inferences described herein, inference component 702 can examine the entirety or a subset of the data to which it is granted access and can provide for reasoning about or infer states of the system, environment, etc. from a set of observations as captured via events and/or data. An inference can be employed to identify a specific context or action, or can generate a probability distribution over states, for example. The inference can be probabilistic—that is, the computation of a probability distribution over states of interest based on a consideration of data and events. An inference can also refer to techniques employed for composing higher-level events from a set of events and/or data.

Such an inference can result in the construction of new events or actions from a set of observed events and/or stored event data, whether or not the events are correlated in close temporal proximity, and whether the events and data come from one or several event and data sources. Various classification (explicitly and/or implicitly trained) schemes and/or systems (e.g., support vector machines, neural networks, expert systems, Bayesian belief networks, fuzzy logic, data fusion engines, etc.) can be employed in connection with performing automatic and/or inferred action in connection with the claimed subject matter.

A classifier can map an input attribute vector, x=(x1, x2, x3, x4, xn), to a confidence that the input belongs to a class, such as by f(x)=confidence(class). Such classification can employ a probabilistic and/or statistical-based analysis (e.g., factoring into the analysis utilities and costs) to prognose or infer an action that a user desires to be automatically performed. A support vector machine (SVM) is an example of a classifier that can be employed. The SVM operates by finding a hyper-surface in the space of possible inputs, where the hyper-surface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

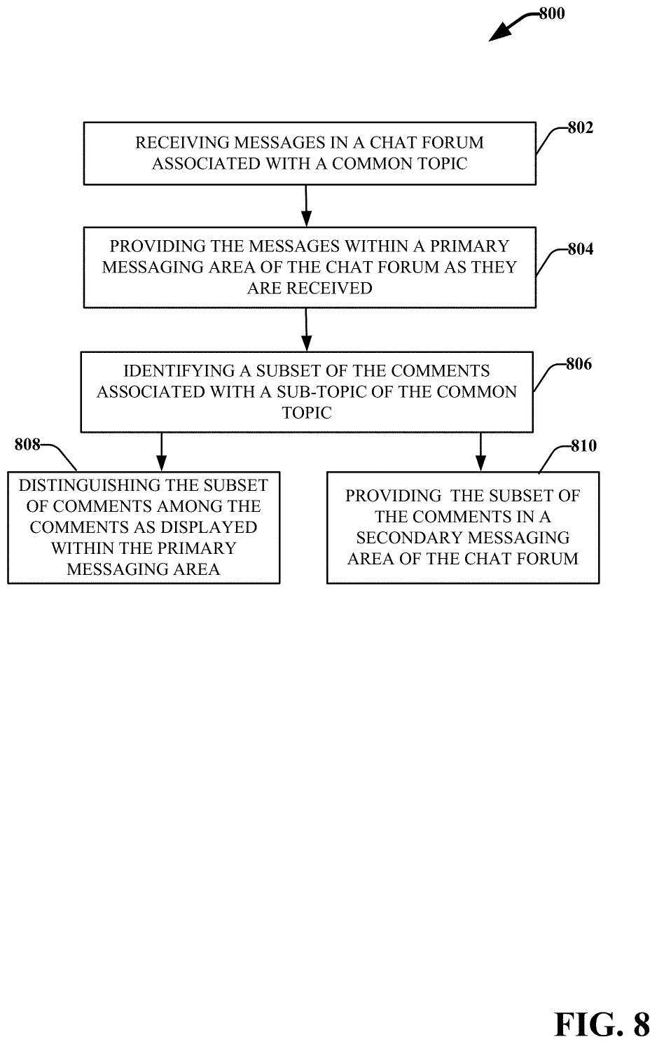

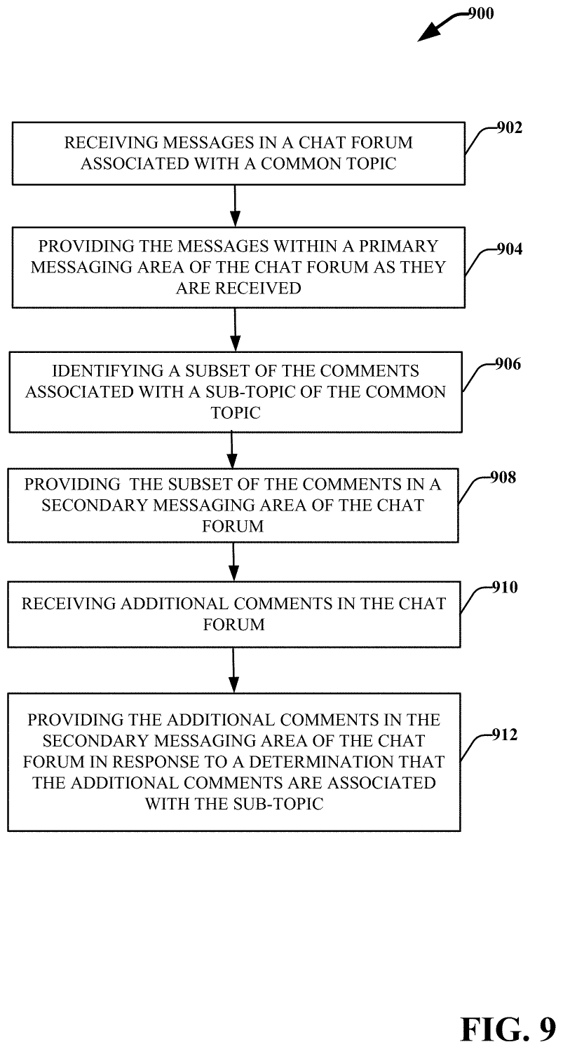

In view of the example systems and/or devices described herein, example methods that can be implemented in accordance with the disclosed subject matter can be further appreciated with reference to flowcharts in FIGS. 8-9. For purposes of simplicity of explanation, example methods disclosed herein are presented and described as a series of acts; however, it is to be understood and appreciated that the disclosed subject matter is not limited by the order of acts, as some acts may occur in different orders and/or concurrently with other acts from that shown and described herein. For example, a method disclosed herein could alternatively be represented as a series of interrelated states or events, such as in a state diagram. Moreover, interaction diagram(s) may represent methods in accordance with the disclosed subject matter when disparate entities enact disparate portions of the methods. Furthermore, not all illustrated acts may be required to implement a method in accordance with the subject specification. It should be further appreciated that the methods disclosed throughout the subject specification are capable of being stored on an article of manufacture to facilitate transporting and transferring such methods to computers for execution by a processor or for storage in a memory.

FIG. 8 illustrates a flow chart of an example method 800 for identifying and extracting or distinguishing sub-conversations within a live chat session, in accordance with various aspects and embodiments described herein At 802, messages are received in a chat forum associated with a common topic (e.g., via reception component 110). At 804, the messages are provided within a primary messaging area of the chat forum as they are received (e.g., via primary dialogue component 106). At 806, a subset of the comments associated with a sub-topic of the common topic are identified (e.g., via identification component 112). Method 800 can then proceed either with 808, wherein the subset of comments are distinguished among the comments as displayed within the primary messaging area (e.g., via highlighting in a different color than other messages) or with 810 wherein the subset of the comments are provided in a secondary messaging area of the chat forum (e.g., in a separate new window).

FIG. 9 illustrates a flow chart of another example method 900 for identifying and extracting or distinguishing sub-conversations within a live chat session, in accordance with various aspects and embodiments described herein At 902, messages are received in a chat forum associated with a common topic (e.g., via reception component 110). At 904, the messages are provided within a primary messaging area of the chat forum as they are received (e.g., via primary dialogue component 106). At 906, a subset of the comments associated with a sub-topic of the common topic are identified (e.g., via identification component 112). At 908, the subset of the comments are provided in a secondary messaging area of the chat forum (e.g., in a separate new window, via sub-dialogue component 108). At 910, additional comments are received in the chat forum (e.g., via reception component 110), and at 912 the additional comments are provided in the secondary messaging area of the chat forum in response to a determination that the additional comments are associated with the sub-topic (e.g., via sub-dialogue component 108 and identification component 112).

### Example Operating Environments

The systems and processes described below can be embodied within hardware, such as a single integrated circuit (IC) chip, multiple ICs, an application specific integrated circuit (ASIC), or the like. Further, the order in which some or all of the process blocks appear in each process should not be deemed limiting. Rather, it should be understood that some of the process blocks can be executed in a variety of orders, not all of which may be explicitly illustrated in this disclosure.

With reference to FIG. 10, a suitable environment 1000 for implementing various aspects of the claimed subject matter includes a computer 1002. The computer 1002 includes a processing unit 1004, a system memory 1006, a codec 1005, and a system bus 1008. The system bus 1008 couples system components including, but not limited to, the system memory 1006 to the processing unit 1004. The processing unit 1004 can be any of various available processors. Dual microprocessors and other multiprocessor architectures also can be employed as the processing unit 1004.

The system bus 1008 can be any of several types of bus structure(s) including the memory bus or memory controller, a peripheral bus or external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 13104), and Small Computer Systems Interface (SCSI).

The system memory 1006 includes volatile memory 1010 and non-volatile memory 1012. The basic input/output system (BIOS), containing the basic routines to transfer information between elements within the computer 1002, such as during start-up, is stored in non-volatile memory 1012. In addition, according to present innovations, codec 1005 may include at least one of an encoder or decoder, wherein the at least one of an encoder or decoder may consist of hardware, a combination of hardware and software, or software. Although, codec 1005 is depicted as a separate component, codec 1005 may be contained within non-volatile memory 1012. By way of illustration, and not limitation, non-volatile memory 1012 can include read only memory (ROM), programmable ROM (PROM), electrically programmable ROM (EPROM), electrically erasable programmable ROM (EEPROM), or flash memory. Volatile memory 1010 includes random access memory (RAM), which acts as external cache memory. According to present aspects, the volatile memory may store the write operation retry logic (not shown in FIG. 10) and the like. By way of illustration and not limitation, RAM is available in many forms such as static RAM (SRAM), dynamic RAM (DRAM), synchronous DRAM (SDRAM), double data rate SDRAM (DDR SDRAM), and enhanced SDRAM (ESDRAM.

Computer 1002 may also include removable/non-removable, volatile/non-volatile computer storage medium. FIG. 10 illustrates, for example, disk storage 1014. Disk storage 1014 includes, but is not limited to, devices like a magnetic disk drive, solid state disk (SSD) floppy disk drive, tape drive, Jaz drive, Zip drive, LS-70 drive, flash memory card, or memory stick. In addition, disk storage 1014 can include storage medium separately or in combination with other storage medium including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1014 to the system bus 1008, a removable or non-removable interface is typically used, such as interface 1016.

It is to be appreciated that FIG. 10 describes software that acts as an intermediary between users and the basic computer resources described in the suitable operating environment 1000. Such software includes an operating system 1018. Operating system 1018, which can be stored on disk storage 1014, acts to control and allocate resources of the computer system 1002. Applications 1020 take advantage of the management of resources by operating system 1018 through program modules 1024, and program data 1026, such as the boot/shutdown transaction table and the like, stored either in system memory 1006 or on disk storage 1014. It is to be appreciated that the claimed subject matter can be implemented with various operating systems or combinations of operating systems.

A user enters commands or information into the computer 1002 through input device(s) 1028. Input devices 1028 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1004 through the system bus 1008 via interface port(s) 1030. Interface port(s) 1030 include, for example, a serial port, a parallel port, a game port, and a universal serial bus (USB). Output device(s) 1036 use some of the same type of ports as input device(s). Thus, for example, a USB port may be used to provide input to computer 1002, and to output information from computer 1002 to an output device 1036. Output adapter 1034 is provided to illustrate that there are some output devices 1036 like monitors, speakers, and printers, among other output devices 1036, which require special adapters. The output adapters 1034 include, by way of illustration and not limitation, video and sound cards that provide a means of connection between the output device 1036 and the system bus 1008. It should be noted that other devices and/or systems of devices provide both input and output capabilities such as remote computer(s) 1038.

Computer 1002 can operate in a networked environment using logical connections to one or more remote computers, such as remote computer(s) 1038. The remote computer(s) 1038 can be a personal computer, a server, a router, a network PC, a workstation, a microprocessor based appliance, a peer device, a smart phone, a tablet, or other network node, and typically includes many of the elements described relative to computer 1002. For purposes of brevity, only a memory storage device 1040 is illustrated with remote computer(s) 1038. Remote computer(s) 1038 is logically connected to computer 1002 through a network interface 1042 and then connected via communication connection(s) 1044. Network interface 1042 encompasses wire and/or wireless communication networks such as local-area networks (LAN) and wide-area networks (WAN) and cellular networks. LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 1044 refers to the hardware/software employed to connect the network interface 1042 to the bus 1008. While communication connection 1044 is shown for illustrative clarity inside computer 1002, it can also be external to computer 1002. The hardware/software necessary for connection to the network interface 1042 includes, for exemplary purposes only, internal and external technologies such as, modems including regular telephone grade modems, cable modems and DSL modems, ISDN adapters, and wired and wireless Ethernet cards, hubs, and routers.

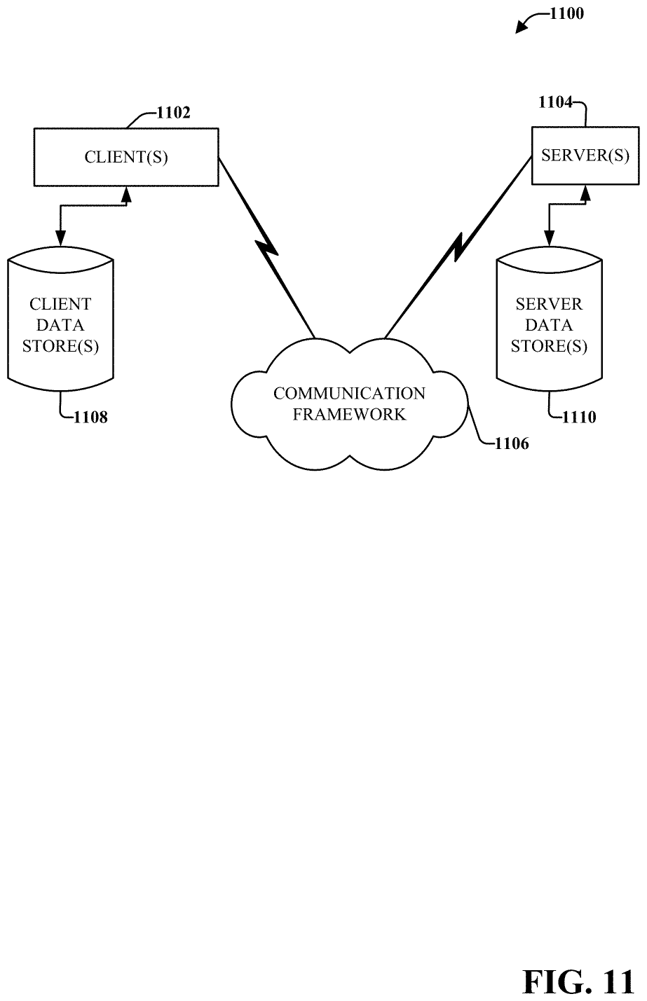

Referring now to FIG. 11, there is illustrated a schematic block diagram of a computing environment 1100 in accordance with this disclosure. The system 1100 includes one or more client(s) 1102 (e.g., laptops, smart phones, PDAs, media players, computers, portable electronic devices, tablets, and the like). The client(s) 1102 can be hardware and/or software (e.g., threads, processes, computing devices). The system 1100 also includes one or more server(s) 1104. The server(s) 1104 can also be hardware or hardware in combination with software (e.g., threads, processes, computing devices). The servers 1104 can house threads to perform transformations by employing aspects of this disclosure, for example. One possible communication between a client 1102 and a server 1104 can be in the form of a data packet transmitted between two or more computer processes wherein the data packet may include video data. The data packet can include a metadata, e.g., associated contextual information, for example. The system 1100 includes a communication framework 1106 (e.g., a global communication network such as the Internet, or mobile network(s)) that can be employed to facilitate communications between the client(s) 1102 and the server(s) 1104.

Communications can be facilitated via a wired (including optical fiber) and/or wireless technology. The client(s) 1102 include or are operatively connected to one or more client data store(s) 1108 that can be employed to store information local to the client(s) 1102 (e.g., associated contextual information). Similarly, the server(s) 1104 are operatively include or are operatively connected to one or more server data store(s) 1110 that can be employed to store information local to the servers 1104.

In one embodiment, a client 1102 can transfer an encoded file, in accordance with the disclosed subject matter, to server 1104. Server 1104 can store the file, decode the file, or transmit the file to another client 1102. It is to be appreciated, that a client 1102 can also transfer uncompressed file to a server 1104 and server 1104 can compress the file in accordance with the disclosed subject matter. Likewise, server 1104 can encode video information and transmit the information via communication framework 1106 to one or more clients 1102.

The illustrated aspects of the disclosure may also be practiced in distributed computing environments where certain tasks are performed by remote processing devices that are linked through a communications network. In a distributed computing environment, program modules can be located in both local and remote memory storage devices.

Moreover, it is to be appreciated that various components described in this description can include electrical circuit(s) that can include components and circuitry elements of suitable value in order to implement the embodiments of the subject innovation(s). Furthermore, it can be appreciated that many of the various components can be implemented on one or more integrated circuit (IC) chips. For example, in one embodiment, a set of components can be implemented in a single IC chip. In other embodiments, one or more of respective components are fabricated or implemented on separate IC chips.

What has been described above includes examples of the embodiments of the present invention. It is, of course, not possible to describe every conceivable combination of components or methodologies for purposes of describing the claimed subject matter, but it is to be appreciated that many further combinations and permutations of the subject innovation are possible. Accordingly, the claimed subject matter is intended to embrace all such alterations, modifications, and variations that fall within the spirit and scope of the appended claims. Moreover, the above description of illustrated embodiments of the subject disclosure, including what is described in the Abstract, is not intended to be exhaustive or to limit the disclosed embodiments to the precise forms disclosed. While specific embodiments and examples are described in this disclosure for illustrative purposes, various modifications are possible that are considered within the scope of such embodiments and examples, as those skilled in the relevant art can recognize.

In particular and in regard to the various functions performed by the above described components, devices, circuits, systems and the like, the terms used to describe such components are intended to correspond, unless otherwise indicated, to any component which performs the specified function of the described component (e.g., a functional equivalent), even though not structurally equivalent to the disclosed structure, which performs the function in the disclosure illustrated exemplary aspects of the claimed subject matter. In this regard, it will also be recognized that the innovation includes a system as well as a computer-readable storage medium having computer-executable instructions for performing the acts and/or events of the various methods of the claimed subject matter.

The aforementioned systems/circuits/modules have been described with respect to interaction between several components/blocks. It can be appreciated that such systems/circuits and components/blocks can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components may be combined into a single component providing aggregate functionality or divided into several separate sub-components, and any one or more middle layers, such as a management layer, may be provided to communicatively couple to such sub-components in order to provide integrated functionality. Any components described in this disclosure may also interact with one or more other components not specifically described in this disclosure but known by those of skill in the art.

In addition, while a particular feature of the subject innovation may have been disclosed with respect to only one of several implementations, such feature may be combined with one or more other features of the other implementations as may be desired and advantageous for any given or particular application. Furthermore, to the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

As used in this application, the terms “component,” “module,” “system,” or the like are generally intended to refer to a computer-related entity, either hardware (e.g., a circuit), a combination of hardware and software, software, or an entity related to an operational machine with one or more specific functionalities. For example, a component may be, but is not limited to being, a process running on a processor (e.g., digital signal processor), a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers. Further, a “device” can come in the form of specially designed hardware; generalized hardware made specialized by the execution of software thereon that enables the hardware to perform specific function; software stored on a computer readable storage medium; software transmitted on a computer readable transmission medium; or a combination thereof.

Moreover, the words “example” or “exemplary” are used in this disclosure to mean serving as an example, instance, or illustration. Any aspect or design described in this disclosure as “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Computing devices typically include a variety of media, which can include computer-readable storage media and/or communications media, in which these two terms are used in this description differently from one another as follows. Computer-readable storage media can be any available storage media that can be accessed by the computer, is typically of a non-transitory nature, and can include both volatile and nonvolatile media, removable and non-removable media. By way of example, and not limitation, computer-readable storage media can be implemented in connection with any method or technology for storage of information such as computer-readable instructions, program modules, structured data, or unstructured data. Computer-readable storage media can include, but are not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or other tangible and/or non-transitory media which can be used to store desired information. Computer-readable storage media can be accessed by one or more local or remote computing devices, e.g., via access requests, queries or other data retrieval protocols, for a variety of operations with respect to the information stored by the medium.

On the other hand, communications media typically embody computer-readable instructions, data structures, program modules or other structured or unstructured data in a data signal that can be transitory such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

In view of the exemplary systems described above, methodologies that may be implemented in accordance with the described subject matter will be better appreciated with reference to the flowcharts of the various figures. For simplicity of explanation, the methodologies are depicted and described as a series of acts. However, acts in accordance with this disclosure can occur in various orders and/or concurrently, and with other acts not presented and described in this disclosure. Furthermore, not all illustrated acts may be required to implement the methodologies in accordance with certain aspects of this disclosure. In addition, those skilled in the art will understand and appreciate that the methodologies could alternatively be represented as a series of interrelated states via a state diagram or events. Additionally, it should be appreciated that the methodologies disclosed in this disclosure are capable of being stored on an article of manufacture to facilitate transporting and transferring such methodologies to computing devices. The term article of manufacture, as used in this disclosure, is intended to encompass a computer program accessible from any computer-readable device or storage media.

1. A system, comprising:
a memory; and
a processor coupled to the memory that is configured to:
receive comments associated with a primary topic, wherein at least a portion of the received comments are displayed in a first comments window of a graphical user interface concurrently with a media content item in a video window;
apply a classifier to the comments associated with the media item, wherein the classifier maps each comment to a confidence that a comment belongs to a sub-conversation topic associated with the primary topic;
identify, based on the confidence determined by applying the classifier to each of the comments, a subset of comments from the received comments that are associated with the sub-conversation topic associated with the primary topic;
remove the subset of comments that are associated with the sub-conversation topic from the received comments that are displayed in the first comments window and replace each of the subset of comments with a marker linked to the sub-conversation topic being displayed in a second comments window;
in response to identifying the subset of comments, update the graphical user interface to display the media content item in the video window, a remaining portion of the received comments in the first comments window in which the at least a portion of the received comments are identified by the primary topic, and at least a portion of the subset of comments in the second comments window in which the at least a portion of the subset of comments are identified by the sub-conversation topic;
continue receiving at least one additional comment associated with the primary topic;
prior to displaying the at least one additional comment in the first comments window, determine whether the at least one additional comment is associated with the sub-conversation topic associated with the primary topic based on a result of applying the classifier and based on an indication associated with the at least one additional comment received from a user other than a user who transmitted the at least one additional comment; and
in response to determining that the at least one additional comment is associated with the sub-conversation topic that is associated with the primary topic, update the graphical user interface to insert the at least one additional comment into the second comments window that includes the at least a portion of the subset of comments.

2. The system of claim 1, wherein the media item is a live streaming media item being presented to a plurality of devices, and wherein the graphical user interface or another graphical user interface is presented via the plurality of devices via a network interface.

3. The system of claim 1, wherein the processor is further configured to identify the subset of comments as respective comments associated with the media item are received, wherein respective comments of the subset of comments are distinguished among the received comments as displayed via the graphical user interface automatically as they are received.

4. The system of claim 1, wherein the processor is further configured to identify two or more different subsets of the received comments respectively associated with two or more different sub-conversation topics.

5. The system of claim 1, wherein the processor is further configured to distinguish the subset of comments by presenting a unique symbol associated therewith in connection with each comment in the subset of comments.

6. The system of claim 5, wherein the unique symbol associated with the comment is applied to the comment by a user.

7. The system of claim 1, wherein a comment from the received comments is provided by a distinguished user as identified by a symbol or tag associated with the distinguished user, and wherein the processor is further configured to identify the subset of comments based at least in part on a determination that the subset of comments are responsive to the comment provided by the distinguished user.

8. The system of claim 7, wherein the symbol or tag associated with the distinguished user is applied to the distinguished user by another user.

9. The system of claim 1, wherein the processor is further configured to identify the subset of the comments based on automated analysis of text of the comments and defined relationships between words included in the text.

10. (canceled)

11. The system of claim 1, wherein the subset of comments are distinguished among the received comments as displayed via the graphical user interface by displaying the second comments window in a separate area of the graphical user interface that is adjacent to the first comments window.

12. The system of claim 1, wherein the subset of comments are distinguished among the received comments as displayed via another graphical user interface by inclusion of the subset of the comments in a separate window.

13. The system of claim 1, wherein the subset of comments are distinguished among the received comments as displayed via the graphical user interface by highlighting respective comments in the subset with a distinguishable color or font.

14-17. (canceled)

18. A method comprising:
receiving, using a hardware processor, comments associated with a primary topic, wherein at least a portion of the received comments are displayed in a first comments window of a graphical user interface concurrently with a media content item in a video window;
applying, using the hardware processor, a classifier to the comments associated with the media item, wherein the classifier maps each comment to a confidence that a comment belongs to a sub-conversation topic associated with the primary topic;
identifying, using the hardware processor, based on the confidence determined by applying the classifier to each of the comments, a subset of comments from the received comments that are associated with the sub-conversation topic associated with the primary topic;
removing, using the hardware processor, the subset of comments that are associated with the sub-conversation topic from the received comments that are displayed in the first comments window and replace each of the subset of comments with a marker linked to the sub-conversation topic being displayed in a second comments window;
in response to identifying the subset of comments, updating, using the hardware processor, the graphical user interface to display the media content item in the video window, a remaining portion of the received comments in the first comments window in which the at least a portion of the received comments are identified by the primary topic, and at least a portion of the subset of comments in the second comments window in which the at least a portion of the subset of comments are identified by the sub-conversation topic;
receiving, using the hardware processor, at least one additional comment associated with the primary topic;
prior to displaying the at least one additional comment in the first comments window, determining, using the hardware processor whether the at least one additional comment is associated with the sub-conversation topic associated with the primary topic based on a result of applying the classifier and based on an indication associated with the at least one additional comment received from a user other than a user who transmitted the at least one additional comment; and
in response to determining that the at least one additional comment is associated with the sub-conversation topic that is associated with the primary topic, updating, using the hardware processor, the graphical user interface to insert the at least one additional comment into the second comments window that includes the at least a portion of the subset of comments.

19. The method of claim 18, wherein the identifying the subset of comments is based on automated analysis of text of the comments and defined relationships between words included in the text.

20. The method of claim 18, further comprising:
receiving additional comments associated with the media item; and
distinguishing the additional comments among the received comments in response to a determination that the additional comments are associated with the sub-conversation topic.

21. A non-transitory computer-readable medium containing computer-executable instructions that, when executed by a processor, cause the processor to perform a method, the method comprising:
receiving comments associated with a primary topic, wherein at least a portion of the received comments are displayed in a first comments window of a graphical user interface concurrently with a media content item in a video window;
applying a classifier to the comments associated with the media item, wherein the classifier maps each comment to a confidence that a comment belongs to a sub-conversation topic associated with the primary topic;
identifying, based on the confidence determined by applying the classifier to each of the comments, a subset of comments from the received comments that are associated with the sub-conversation topic associated with the primary topic;
removing the subset of comments that are associated with the sub-conversation topic from the received comments that are displayed in the first comments window and replace each of the subset of comments with a marker linked to the sub-conversation topic being displayed in a second comments window;
in response to identification of the subset of comments, updating the graphical user interface to display the media content item in the video window, a remaining portion of the received comments in the first comments window in which the at least a portion of the received comments are identified by the primary topic, and at least a portion of the subset of comments in the second comments window in which the at least a portion of the subset of comments are identified by the sub-conversation topic;
receiving at least one additional comment associated with the primary topic;
prior to displaying the at least one additional comment in the first comments window, determining whether the at least one additional comment is associated with the sub-conversation topic associated with the primary topic based on a result of applying the classifier and based on an indication associated with the at least one additional comment received from a user other than a user who transmitted the at least one additional comment; and
in response to determining that the at least one additional comment is associated with the sub-conversation topic that is associated with the primary topic, update the graphical user interface to insert the at least one additional comment into the second comments window that includes the at least a portion of the subset of comments.
